(19) United States
(12) Patent Application Publication
(10) Pub. No.: US 2009/0160135 A1
(43) Pub. Date: Jun. 25, 2009

(54) LABYRINTH SEAL WITH REDUCED LEAKAGE FLOW BY GROOVES AND TEETH SYNERGISTIC ACTION

(76) Inventors: Gabriele Turini, La Rotta (IT); Leonardo Baldassarre, Firenze (IT); Andrea Cianti, Firenze (IT)

Correspondence Address: General Electric Company;GE Global Patent Operation, PO Box 861, 2 Corporate Drive, Suite 648, Shelton, CT, 06484, US

(21) Appl. No.: 11/960,794

(22) Filed: Dec. 20, 2007

(51) Int. Cl. F16J 15/447

(52) U.S. Cl. 277/418

(57) ABSTRACT

A labyrinth seal is disclosed having a stator, a plurality of teeth extending from the stator, each teeth having an end portion, and a rotor having an outside surface disposed next to the end portions of the plurality of teeth of the stator. The rotor further includes a plurality of grooves on the outside surface thereof, each groove is disposed between adjacent teeth of the stator, and a cavity formed between adjacent teeth and the each groove is configured to induce a vortex motion to a leakage flow from the high-pressure side to the low-pressure side of the seal so as to reduce a flow rate of the leakage flow. Methods of reducing a leakage flow in labyrinth seal are also disclosed.

### BACKGROUND OF THE INVENTION

1. Field of the Invention

Embodiments of the subject matter disclosed relate generally to seals for rotary machines, such as steam turbines, gas turbines, aircraft engines, and compressors, and more particular to a labyrinth seal with reduced leakage flow by grooves and teeth synergistic action.

2. Description of the Related Art

Rotary machines such as steam and gas turbines used for power generation and mechanical drive applications, aircraft engines used for propulsion, and compressors used for pressurization, are generally large machines consisting of multiple turbine and compressor stages. In such machines, pressurized fluid flowing through the turbine and/or compressor stages passes through a series of stationary and rotary components. For example, in a typical steam turbine, the stationary components may include the machine casing and packing head, and the rotary component is the rotor. Annular seals mounted on the stationary components are used to control leakage of fluid along the path between the stationary and rotary components. FIGS. 1-3 illustrate several conventional “see through” labyrinths seals used to decrease the noted leakages. As shown, the labyrinths seals are normally formed on mechanical barrier teeth configured to reduce clearance between static and rotating parts or other special shape like a honeycomb element also disposed on a static part. FIG. 1 illustrates a labyrinth seal 10 with straight teeth 12 (see through type), FIG. 2 illustrates a labyrinth seal 20 with sloping teeth 22 (see through type), and FIG. 3 shows a honeycomb seal 30 (see through type) that includes a honeycomb housing 32 that surrounds a shaft 34 so as to form a clearance gap 36 there from.

FIG. 4 illustrates in more detail the labyrinth seal 20 of FIG. 2 as an exemplary embodiment of an existing problem. As shown in FIG. 4, the labyrinth seal 20 includes a stator 40 having a plurality of sloping teeth 22 extending from an extremity thereof. The sloping teeth 22 are held in place close to a portion of a cylindrical rotor 42 to seal against leakage from a gas flow from the high-pressure (HP) side of the seal to the low-pressure side (LP) thereof. As noted, the rotor 42 rotates in the direction of the arrow 46 and the leakage flow, illustrated by the bold line 48, takes place on the gases flowing from left to right. As well known in the applicable arts, the inter-stage leakage directly influences centrifugal compressors and turbo-machinery performance.

It would therefore be desirable to develop a labyrinth seal with improved performance so as to increase efficiency of steam turbines, gas turbines, aircraft engines, and compressors by limiting gas recycling inside the machine, thus raising effective process gas flow.

### BRIEF SUMMARY OF THE INVENTION

One or more of the above-summarized needs or others known in the art are addressed by labyrinth seals that include a stator, a plurality of teeth extending from the stator, a rotor disposed next to end portions of the plurality of teeth, the rotor including a plurality of grooves on the outside surface thereof, each groove being disposed between adjacent teeth of the stator, and a cavity on an external surface of the rotor formed between adjacent teeth, each groove being configured to induce a vortex motion to a leakage flow from a high-pressure side to a low-pressure side of the seal so as to reduce a flow rate of the leakage flow.

Labyrinth seals according to embodiments of the disclosed inventions also include a stator, a plurality of teeth extending from the stator, and a rotor disposed next to the end portions of the plurality of teeth of the stator, the rotor further including means for reducing a flow rate of a leakage flow from the high-pressure side to the low-pressure side of the seal.

Methods of reducing a leakage flow in a labyrinth seal are also within the scope of the subject matter disclosed. These methods include the rotating the leakage flow into a vortex in a cavity formed by a groove on an external surface of a rotor and two adjacent teeth of a stator.

The above brief description sets forth features of the various embodiments of the present invention in order that the detailed description that follows may be better understood, and in order that the present contributions to the art may be better appreciated. There are, of course, other features of the invention that will be described hereinafter and which will be for the subject matter of the appended claims.

In this respect, before explaining several embodiments of the invention in detail, it is understood that the various embodiments of the invention are not limited in their application to the details of the construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which the disclosure is based, may readily be utilized as a basis for designing other structures, methods, and/or systems for carrying out the several purposes of the present invention. It is important, therefore, that the claims be regarded as including such equivalent constructions insofar as they do not depart from the spirit and scope of the present invention.

Further, the purpose of the foregoing Abstract is to enable a patent examiner and/or the public generally, and especially scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 illustrates a conventional labyrinth seal with straight teeth and a cylindrical sleeve;

FIG. 2 illustrates a conventional labyrinth seal with sloping teeth and a cylindrical sleeve;

FIG. 3 illustrates a conventional honeycomb seal with a cylindrical sleeve;

FIG. 4 illustrates further structural features of the labyrinth seal of FIG. 2; and

FIG. 5 illustrates a labyrinth seal according to an exemplary embodiment of the subject matter disclosed.

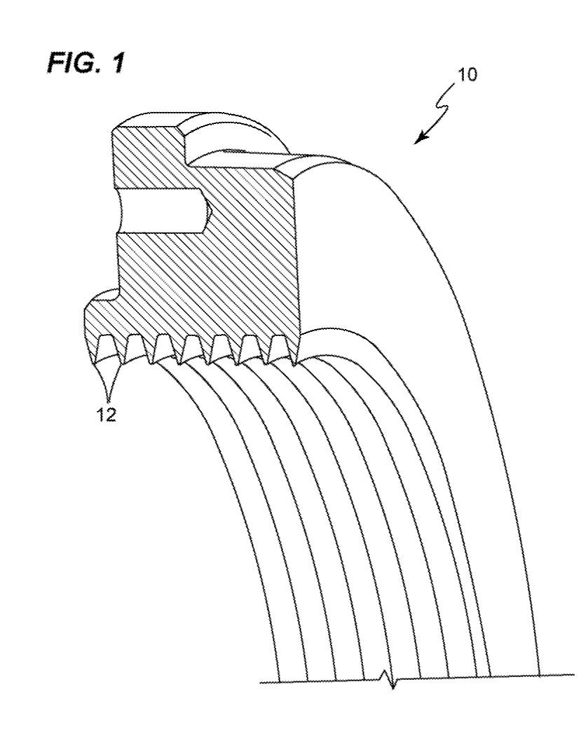

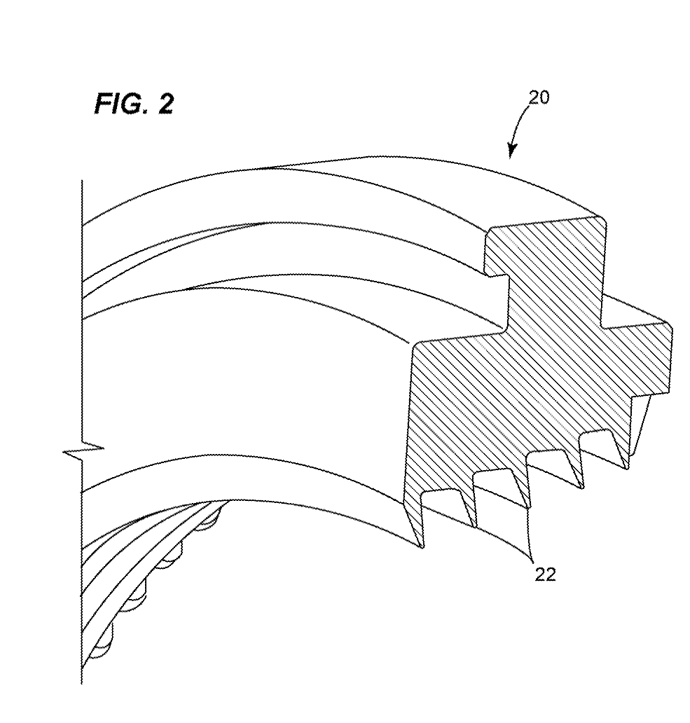

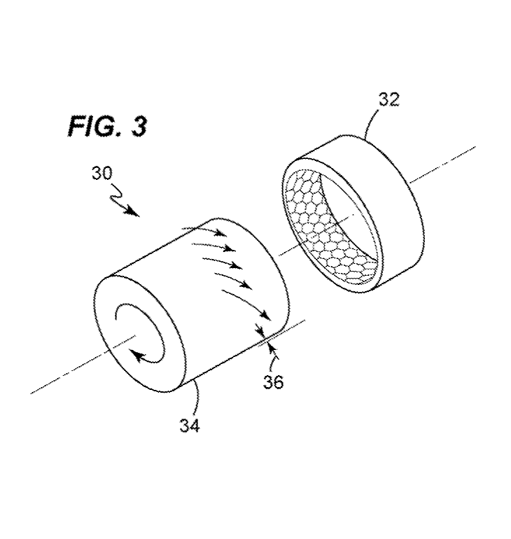

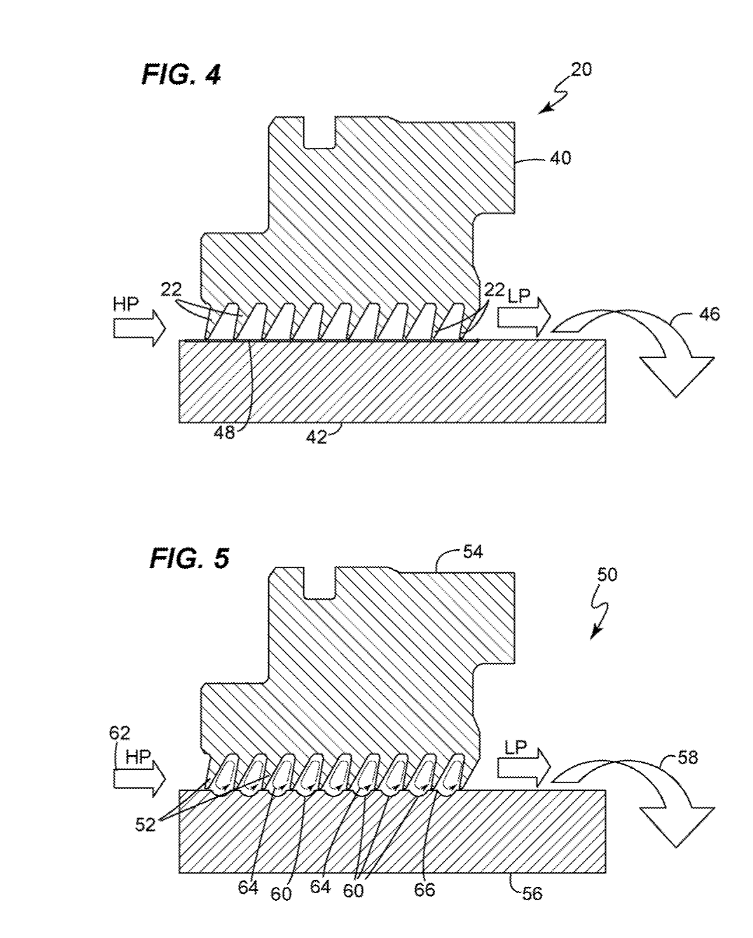

### DETAILED DESCRIPTION OF THE PREFERRED EMBODIMENTS

Embodiments of the subject matter disclosed relate generally to seals for rotary machines, such as steam turbines, gas turbines, aircraft engines, and compressors, and more particular to a labyrinth seal with reduced leakage flow by grooves and teeth synergistic action. As it will become more apparent from the detailed description of the subject matter disclosed herein, by causing a recirculation of the leakage flow between each tooth of a labyrinth seal, a substantial decrease in leakage flow results, thus creating a labyrinth seal with improved performance so as to increase efficiency of steam turbines, gas turbines, aircraft engines, and compressors by limiting gas recycling inside the machine, thus raising effective process gas flow. Those of ordinary skill will appreciate that the various embodiments disclosed herein for minimizing and/or eliminating seal leakage are not dependent on each other, i.e., each may be implemented without the other and various combinations are within the scope of the subject matter disclosed, as it will become apparent. Referring now to the drawings, wherein like reference numerals designate identical or corresponding parts throughout the several views, several embodiments of the improved labyrinth seal systems will be described.

FIG. 5 shows a cross-sectional view of a labyrinth seal 50 according to an exemplary embodiment of the subject matter disclosed. As shown, the labyrinth seal 50 includes a plurality of teeth 52 extending from a stator 54. End portions of the teeth 52 are held in close proximity of a rotor 56, which rotates in the direction of arrow 58. As also shown, the rotor 56 includes a plurality of grooves 60 on its external surface, each groove 60 being disposed between adjacent teeth 52 of the stator 54. In operation, the grooves 60 induce a vortex motion 64 to the leakage flow 62 flowing from the high-pressure (HP) side to the low-pressure (LP) of the labyrinth seal 50 inside of the cavity formed between each tooth 52 and groove 60, thereby blocking the natural flow path for the leakage flow 62 and reducing its flow rate. As shown in FIG. 5, between each groove 60, the external surface of the rotor 56 further includes a flat portion 66 next to each end portion of the teeth 52 of the stator 54.

Thus, one of the advantageous features of the disclosed labyrinth seal is the creation of a synergistic action between the static seal labyrinth and the rotating sleeve with special grooves. Modifying the cylindrical sleeve shape by making appropriate grooves generates a barrier effect to the leakage flow, thus reducing its flow rate by an effective vortex blockage action to the natural flow path for the leakage.

The embodiment of FIG. 5 includes teeth 52 that are sloped. Nevertheless, teeth 52 that are straight are also within the scope of the subject matter disclosed. The inclination of the sloped teeth 52 may vary from about 10° to about 50°, depending on the application. In one favored embodiment, the inclination is about 2020 . In addition, although the shape of the grooves 60 are shown as circular in FIG. 5, other shapes, as for example, but not as a limitation, elliptical are also with the scope of the disclosed embodiments. Several variations of the grooves 60 are within the scope of the disclosed subject matter. For example, but not as a limitation, the grooves 60 may be formed as a concavity (the depth to diameter ratio of each concavity being specified as a function of an intended application), a hemisphere or by any portion of a depression surface sector of a full hemisphere, an inverted or truncated cone, and a cone pit, to name just a few.

As appreciated by those of ordinary skill in the applicable arts, once this new labyrinth seal design is standardized, it could be applied to critical centrifugal compressors where conventional seals do not meet desired standard performance. Computational Fluid Dynamics simulations of the disclosed seal performance indicate a reduction in leakage of 44%, cutting the leakage flow from 1.956 kg/s obtained for the simulation of a standard seal down to 1.089 kg/s for a seal having the structural features disclosed herein. In such simulations, the inlet stagnation pressure used as boundary condition was 371 bar at HP side of the seal for a gas with an inlet temperature of 45° C. and an outlet static pressure of 227 bar at the LP side of the seal. The rotor rotational speed used for the simulations was 10650 RPM and other fluid properties included: dynamic viscosity of 2.84×10-5 N s/m², thermal conductivity of 0.0852 W/m K, ideal gas constant of 352.64 J/kg K, ratio of specific heats of 1.3, molecular weight of 20.55, specific heat at constant pressure of 1528.11 J/kg K, and modified molecular weight of 23.576.

Methods for controlling the temperature of a battery are also within the scope of the subject matter disclosed herein. Such methods include: the transferring range includes flowing a liquid through a plurality of liquid-circulating cooling plates within the battery.

Methods of reducing a leakage flow from a high-pressure side to a low-pressure side of a labyrinth seal comprising a stator, a plurality of teeth extending from the stator, and a rotor having an outside surface disposed next to end portions of the plurality of teeth of the stator. These methods include the rotating the leakage flow into a vortex in a cavity formed by a groove on an external surface of the rotor and two adjacent teeth of the stator. The rotating may further include the rotating of the leakage flow in a cavity formed by the groove and two adjacent sloping teeth of the stator, the cavity having either a circular or elliptical shape and the rotor having a flat portion on the external surface thereof next to end portions of the plurality of teeth.

While the disclosed embodiments of the subject matter described herein have been shown in the drawings and fully described above with particularity and detail in connection with several exemplary embodiments, it will be apparent to those of ordinary skill in the art that many modifications, changes, and omissions are possible without materially departing from the novel teachings, the principles and concepts set forth herein, and advantages of the subject matter recited in the appended claims. Hence, the proper scope of the disclosed innovations should be determined only by the broadest interpretation of the appended claims so as to encompass all such modifications, changes, and omissions. In addition, the order or sequence of any process or method steps may be varied or re-sequenced according to alternative embodiments. Finally, in the claims, any means-plus-function clause is intended to cover the structures described herein as performing the recited function and not only structural equivalents, but also equivalent structures.

What is claimed is:

1. A labyrinth seal having a high-pressure side and a low-pressure side, the seal comprising:
a stator;
a plurality of teeth extending from the stator, each teeth having an end portion; and
a rotor having an outside surface disposed next to the end portions of the plurality of teeth of the stator, wherein the rotor comprises a plurality of grooves on the outside surface thereof, each groove is disposed between adjacent teeth of the stator, and a cavity formed between adjacent teeth and the each groove is configured to induce a vortex motion to a leakage flow from the high-pressure side to the low-pressure side of the seal so as to reduce a flow rate of the leakage flow.

2. The seal according to claim 1, wherein the plurality of teeth comprises a plurality of sloping teeth.

3. The seal according to claim 1, wherein each groove has a circular shape.

4. The seal according to claim 1, wherein each groove has an elliptical shape.

5. The seal according to claim 1, wherein external surface of the rotor further comprises a flat portion next to the end portion of each tooth of the stator.

6. The seal according the claim 1, wherein the flow rate is reduced by 44% as compared to a flow rate in a seal without the grooves.

7. A rotary machine selected from the group consisting of a steam turbine, a gas turbine, an aircraft engine, and a compressor, the rotary machine including the seal according the claim 1.

8. A labyrinth seal having a high-pressure side and a low-pressure side, the seal comprising:
a stator;
a plurality of teeth extending from the stator, each teeth having an end portion; and
a rotor disposed next to the end portions of the plurality of teeth of the stator, the rotor further comprising means for reducing a flow rate of a leakage flow from the high-pressure side to the low-pressure side of the seal.

9. A method of reducing a leakage flow from a high-pressure side to a low-pressure side of a labyrinth seal comprising a stator, a plurality of teeth extending from the stator, and a rotor having an outside surface disposed next to end portions of the plurality of teeth of the stator, the method comprising:
rotating the leakage flow into a vortex in a cavity formed by a groove on an external surface of the rotor and two adjacent teeth of the stator.

10. The method according to claim 9, wherein the rotating further includes rotating the leakage flow into the vortex in a cavity formed by the groove and two adjacent sloping teeth of the stator.

11. The method according to claim 9, wherein the rotating further includes rotating the leakage flow into the vortex in the cavity having a circular shape, the cavity being formed by the groove and two adjacent teeth of the stator.

12. The method according to claim 9, wherein the rotating further includes rotating the leakage flow into the vortex in the cavity having an elliptical shape, the cavity being formed by the groove and two adjacent teeth of the stator.

13. The method according to claim 9, wherein the rotating further includes rotating the leakage flow into the vortex in the cavity formed by the groove and two adjacent teeth of the stator, each teeth having an end portion adjacent to a flat portion on the outside surface of the rotor.

14. The method according to claim 9, a flow rate of the leakage flow is reduced by 44% as compared to a flow rate in a seal without the grooves.
